(19) United States
(12) Patent Application Publication
(10) Pub. No.: US 2020/0379988 A1
(43) Pub. Date: Dec. 3, 2020

(54) ROW-LEVEL WORKSHEET SECURITY

(71) Applicant: SIGMA COMPUTING, INC., SAN FRANCISCO, CA (US)

(72) Inventor: MAX H. SEIDEN, SAN FRANCISCO, CA (US)

(21) Appl. No.: 15/930,936

(22) Filed: May 13, 2020

Related U.S. Application Data
(60) Provisional application No. 62/853,870, filed on May 29, 2019.

(51) Int. Cl. G06F 16/242; G06F 16/28; G06F 21/62; G06F 16/22

(52) U.S. Cl. CPC G06F 16/2428; G06F 16/221; G06F 21/6227; G06F 16/284

(57) ABSTRACT

Row-level worksheet security may include creating a referencing worksheet from a data source worksheet, wherein the data source worksheet comprises a function configured to select, based on one or more user-relative functions, at least a subset of a plurality of rows from a data set in a database for presentation; presenting the at least a subset of the plurality of rows by: evaluating the one or more user-relative functions; and selecting, based on the filter, the at least a subset of the plurality of rows.

### BACKGROUND

### Field of the Invention

The field of the invention is data processing, or, more specifically, methods, apparatus, and products for row-level worksheet security.

### Description of Related Art

Modern businesses may store large amounts of data in remote databases within cloud-based data warehouses. This data may be accessed using database query languages, such as structured query language (SQL). However, some query responses may include too much data to present efficiently in a web application.

### SUMMARY

Methods, systems, and apparatus for row-level worksheet security are disclosed in this specification. Row-level worksheet security may include creating a referencing worksheet from a data source worksheet, wherein the data source worksheet comprises a function configured to select, based on one or more user-relative functions, at least a subset of a plurality of rows from a data set in a database for presentation; presenting the at least a subset of the plurality of rows by: evaluating the one or more user-relative functions; and selecting, based on the filter, the at least a subset of the plurality of rows.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for row-level worksheet security according to embodiments of the present invention.

FIG. 2 sets forth a diagram of an example graphical user interface configured for row-level worksheet security according to embodiments of the present invention.

FIG. 3 sets forth a diagram of an example graphical user interface configured for row-level worksheet security according to embodiments of the present invention.

FIG. 4 sets forth a diagram of an example graphical user interface configured for row-level worksheet security according to embodiments of the present invention.

FIG. 5 sets forth a flow chart illustrating an exemplary method for row-level worksheet security according to embodiments of the present invention.

FIG. 6 sets forth a flow chart illustrating an exemplary method for row-level worksheet security according to embodiments of the present invention.

FIG. 7 sets forth a flow chart illustrating an exemplary method for row-level worksheet security according to embodiments of the present invention.

### DETAILED DESCRIPTION

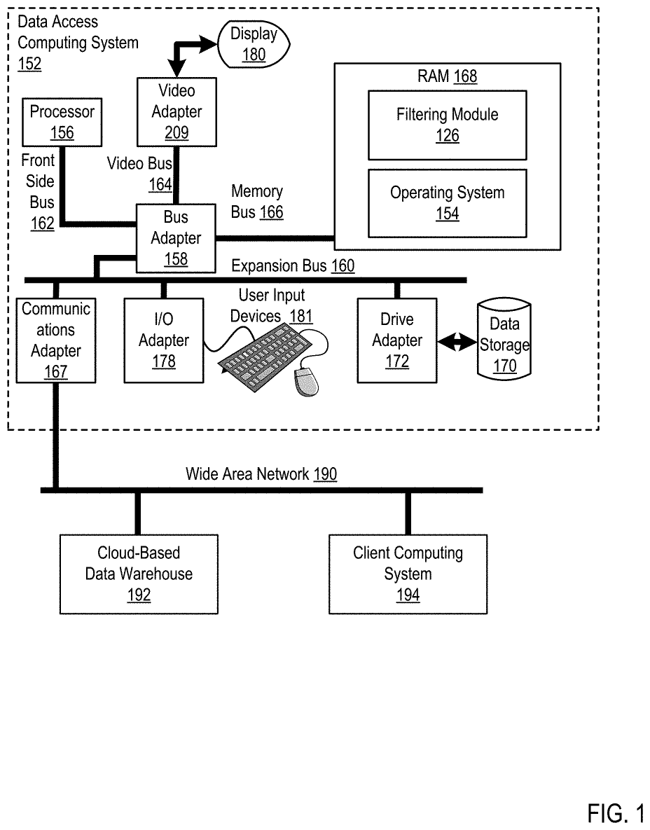

Exemplary methods, apparatus, and products for row-level worksheet security in accordance with the present invention are described with reference to the accompanying drawings, beginning with FIG. 1. FIG. 1 sets forth a block diagram of automated computing machinery comprising an exemplary data access computing system (152) configured for row-level worksheet security according to embodiments of the present invention. The data access computing system (152) of FIG. 1 includes at least one computer processor (156) or ‘CPU’ as well as random access memory (168) (‘RAM’) which is connected through a high speed memory bus (166) and bus adapter (158) to processor (156) and to other components of the data access computing system (152).

Stored in RAM (168) is an operating system (154). Operating systems useful in computers configured for row-level worksheet security according to embodiments of the present invention include UNIX™, Linux™, Microsoft Windows™, AIX™, IBM's i OS™, and others as will occur to those of skill in the art. The operating system (154) in the example of FIG. 1 is shown in RAM (168), but many components of such software typically are stored in non-volatile memory also, such as, for example, on data storage (170), such as a disk drive. Also stored in RAM is the filtering module (126), a module for row-level worksheet security according to embodiments of the present invention.

The data access computing system (152) of FIG. 1 includes disk drive adapter (172) coupled through expansion bus (160) and bus adapter (158) to processor (156) and other components of the data access computing system (152). Disk drive adapter (172) connects non-volatile data storage to the data access computing system (152) in the form of data storage (170). Disk drive adapters useful in computers configured for row-level worksheet security according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example data access computing system (152) of FIG. 1 includes one or more input/output ('I/O′) adapters (178). I/O adapters implement user-oriented input/output through, for example, software drivers and computer hardware for controlling output to display devices such as computer display screens, as well as user input from user input devices (181) such as keyboards and mice. The example data access computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary data access computing system (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for row-level worksheet security according to embodiments of the present invention include modems for wired dial-up communications, Ethernet (IEEE 802.3) adapters for wired data communications, and 802.11 adapters for wireless data communications.

The communications adapter (167) is communicatively coupled to a wide area network (190) that also includes a cloud-based data warehouse (192) and a client computing system (194). The cloud-based data warehouse (192) is a computing system or group of computing systems that hosts a database for access over the wide area network (190). The client computing system (194) is a computing system that accesses the database via the data access computing system (152). The client computing system (194) may access the database using a client application (196), which may include a browser or a dedicated application for accessing the database via the data access computing system (152).

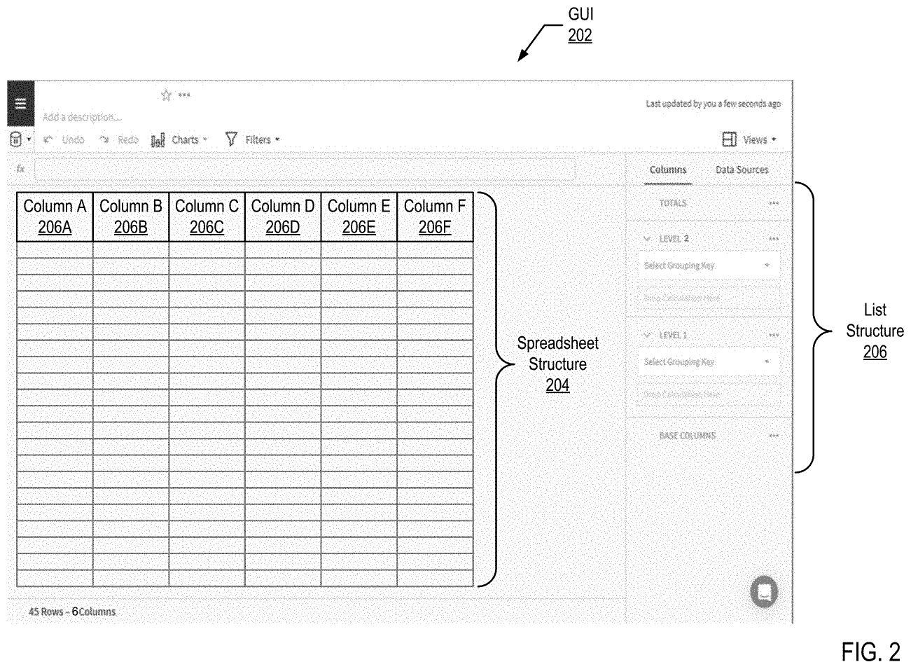

FIG. 2 shows an exemplary user interface for row-level worksheet security according to embodiments of the present invention. Shown is a graphical user interface (GUI) (202). The GUI (202) is a user interface that presents a data set and graphical elements to a user and receives user input from the user. The GUI (202) may be presented, in part, by the filtering module (126) and displayed on a client computing system (194) (e.g., on a system display or mobile touchscreen). The GUI (202) may be encoded by an Internet application hosted on the data access computing system (152) for rendering by the client application (196) of the client computing system (194).

The GUI (202) presents, in part, worksheets to a user. A worksheet (also referred to as a dataset) is a presentation of a data set from a database (206). A referencing worksheet is a worksheet that is linked from another worksheet (referred to as a data source worksheet). The referencing worksheet inherits the data set presented in the data source worksheet (i.e., data not excluded from presentation). The referencing worksheet may also inherit the results of formula applied to other data but not the formulas themselves. The referencing worksheet may be limited to the data set presented or otherwise made available in the data source worksheet (unless the user generating the referencing worksheet has access to excluded data in the database). A referencing worksheet may be linked from any number of data sources, including multiple data source worksheets.

The exemplary GUI (202) includes a spreadsheet structure (204) and a list structure (206). The spreadsheet structure (204) includes a data set (shown as empty rows) with six columns (column A (208A), column B (208B), column C (208C), column D (208D), column E (208E), column F (208F)).

The spreadsheet structure (204) is a graphical element and organizing mechanism for the data set. The spreadsheet structure (204) displays the data within the data set as rows of data organized by columns (column A (208A), column B (208B), column C (208C), column D (208D), column E (208E), column F (208F)). The columns delineate different categories of the data in each row of the data set. The columns may also be calculations using other columns in the data set.

The list structure (206) is a graphical element used to define and organize the hierarchical relationships between the columns (column A (208A), column B (208B), column C (208C), column D (208D), column E (208E), column F (208F)) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure (206) presents a dimensional hierarchy to the user. Specifically, the list structure (206) presents levels arranged hierarchically across at least one dimension. Each level within the list structure (206) is a position within a hierarchical relationship between columns (column A (208A), column B (208B), column C (208C), column D (208D), column E (208E), column F (208F)). The keys within the list structure (206) identify the one or more columns that are the participants in the hierarchical relationship. Each level may have more than one key.

One of the levels in the list structure (206) may be a base level. Columns selected for the base level provide data at the finest granularity. One of the levels in the list structure (206) may be a totals or root level. Columns selected for the totals level provide data at the highest granular level. For example, the totals level may include a field that calculates the sum of each row within a single column of the entire data set (i.e., not partitioned by any other column).

The GUI (202) may enable a user to drag and drop columns (column A (208A), column B (208B), column C (208C), column D (208D), column E (208E), column F (208F)) into the list structure (206). The order of the list structure (206) may specify the hierarchy of the columns relative to one another. A user may be able to drag and drop the columns in the list structure (206) at any time to redefine the hierarchical relationship between columns. The hierarchical relationship defined using the columns selected as keys in the list structure (206) may be utilized in charts such that drilling down (e.g., double click on a bar), enables a new chart to be generated based on a level lower in the hierarchy.

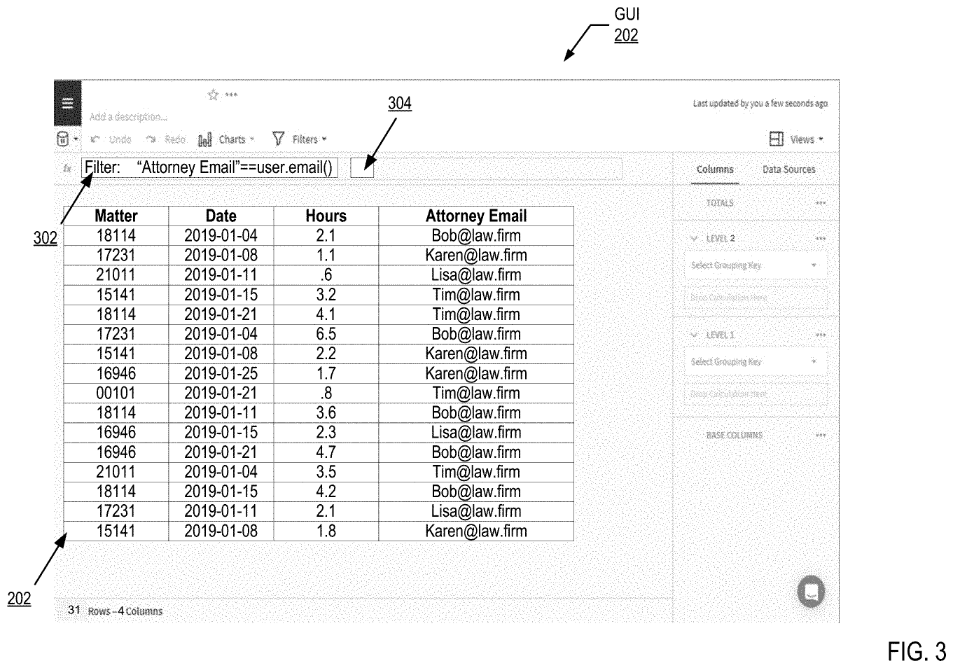

FIG. 3 shows an exemplary user interface for row-level worksheet security according to embodiments of the present invention. Shown is a graphical user interface (GUI) (202). The GUI (202) is a user interface that allows a user to filter a worksheet to include rows having particular values for particular columns. The GUI (202) may be presented, in part, by the filtering module (126) and displayed on a client computing system (194) (e.g., on a system display or mobile touchscreen). The GUI (202) may be encoded by an Internet application hosted on the data access computing system (152) for rendering by the client application (196) of the client computing system (194).

In this example, assume a data set for tracking attorney billings for clients. Each record (e.g., row) corresponds to an amount of billable time worked on a particular client matter by a particular attorney. Accordingly, each row may include columns “Matter” for a matter number, “Date” for a date at which the time was billed, “Hours” for an amount of time billed, and “Attorney Email” for the email address of the attorney billing the time. This data set is reflected in the spreadsheet structure (204) of the worksheet. Continuing with this example, assume that the data set may be accessed via the GUI (202) by various user accounts. Each user account may be associated with various attributes, such as a name, email address, phone number, etc. Attributes of a user account may also include a role. The role of a user account may correspond to a job title or position (e.g., “Partner,” “Associate,” “Paralegal,” etc.). The attributes of a user account may be accessed and exposed through a user-relative function. A user-relative function is a function that, when called, returns an attribute for a user accessing the database via the GUI (202). For example, calling the function user.email( ) would return the email of whatever user is currently accessing the database to cause the function to be called.

The GUI (202) of FIG. 3 may present a data source worksheet. In other words, the worksheet presented in the GUI (202) may correspond to an unrestricted or unfiltered presentation of the data set. The GUI (202) may include a filter input (302) for defining a filter to restrict or hide portions of the data set for presentation. The filter may define criteria to show or hide rows having specific column values or ranges of column values. In other words, the filter may comprise a Boolean operation based one or columns of the data set. The GUI (202) may include a selection box (304) allowing for the filter to be turned on or off (e.g., applied or not applied) to facilitate creation and testing of the filter and the worksheet.

For example, to view all rows for matter number “18114,” the filter may comprise an expression “‘Matter’==‘18114’”. The filter would then select for presentation all rows for which the Boolean expression is true (e.g., all rows having “18114” in the “Matter” column). As another example, to view all rows between Jan. 1, 2019 and Jan. 15, 2019, the filter may comprise an expression “‘Date’>=‘2019-01-04’ AND ‘Date’<=‘2019-01-15’”. The filter would then select for presentation all rows for which the Boolean expression is true (e.g., all rows having a “Date” value between Jan. 1, 2019 and Jan. 15, 2019).

To provide row-level worksheet security, the Boolean expression of the filter may be based on user attributes accessed via a user-relative function. Here, the filter includes an expression “‘Attorney Email’==user.email( )”. This Boolean expression would evaluate as “TRUE” for any row where the value of the “Attorney Email” column matches the email address of the user accessing the database via the GUI (202). Continuing with the example of a data set for billable attorney time, an attorney accessing the data set would only see rows where they are the attorney of record according to the “Attorney Email” column. As another example, the filter may include combinations of user-relative functions. For example, assume the filter includes an expression “‘Attorney Email’==user.email( ) OR user.role( )==‘Partner’”. Using this expression, a user accessing the data set would only see rows where they are the attorney of record according to the “Attorney Email” column unless that user is a “Partner,” who would see all rows.

Referencing worksheets may then be created from this data source worksheet. The referencing worksheets would include the filter as defined in the filter input (302). The user-relative functions would return, on execution, one or more attributes of a user account accessing the referencing worksheet. Based on the user-relative functions referenced in the filter, the filter would evaluate differently for each user. Thus, users accessing the data set using a referencing worksheet may each view differing limited presentations of the data set. The filter may be immutable in the referencing worksheets. This ensures that a user of a referencing worksheet cannot modify or disable the filter in order to see a less or differently restricted presentation of the data set. Row-level security filters may be applied during a query or after the query.

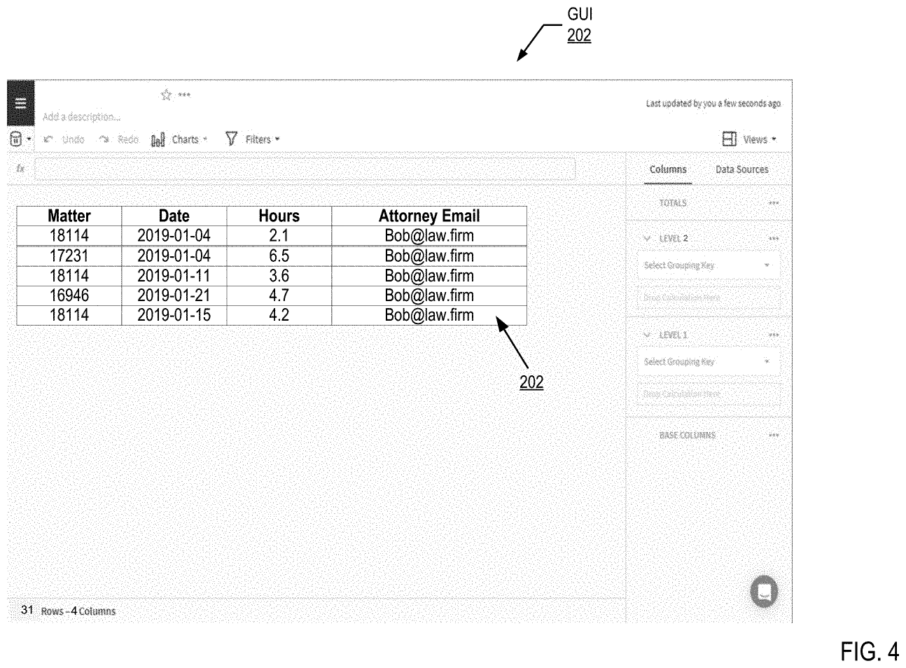

FIG. 4 shows an exemplary user interface for row-level worksheet security according to embodiments of the present invention. Shown is a graphical user interface (GUI) (202). The GUI (202) is a user interface that allows a user to filter a worksheet to include rows having particular values for particular columns. The GUI (202) may be presented, in part, by the filtering module (126) and displayed on a client computing system (194) (e.g., on a system display or mobile touchscreen). The GUI (202) may be encoded by an Internet application hosted on the data access computing system (152) for rendering by the client application (196) of the client computing system (194).

Continuing with the example from FIG. 3, FIG. 4 shows a GUI (202) presenting a reference worksheet based on a data source worksheet of FIG. 3. Assume that the referencing worksheet is being accessed by a user with the email address “Bob@law.firm.” Here, the filter of FIG. 3 (e.g., a Boolean expression “‘Attorney Email’==user.email( )”) has been applied such that only the rows having an “Attorney Email” value of “Bob@law.firm” are presented. The filter input (302) of FIG. 3 has been hidden from the reference worksheet GUI (202) to prevent modification of the applied filter.

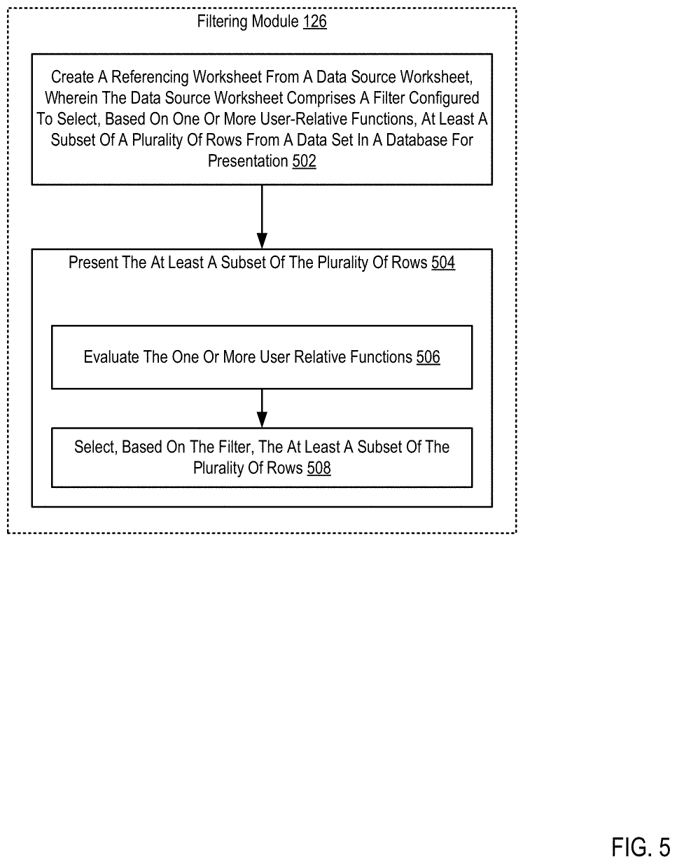

For further explanation, FIG. 5 sets forth a flow chart illustrating an exemplary method for row-level worksheet security according to embodiments of the present invention that includes creating (502) (e.g., by a filtering module (126)) a referencing worksheet from a data source worksheet, wherein the data source worksheet comprises a filter configured to select, based on one or more user-relative functions, at least a subset of a plurality of rows from a data set in a database for presentation. The data source worksheet and the referencing worksheet may comprise presentations of the data set. The referencing worksheet is a worksheet that is linked from the data source worksheet. The referencing worksheet inherits the data set presented in the data source worksheet (i.e., data not excluded from presentation). The referencing worksheet may also inherit the results of formula applied to other data but not the formulas themselves. The referencing worksheet may be limited to the data set presented or otherwise made available in the data source worksheet (unless the user generating the referencing worksheet has access to excluded data in the database). A referencing worksheet may be linked from any number of data sources, including multiple data source worksheets.

The referencing worksheet inherits the filter of the data source worksheet. The filter comprises a Boolean expression based on one or more columns of the data set and the one or more user-relative functions. The one or more user-relative functions are configured to return, on execution, one or more attributes of a user account accessing the referencing worksheet.

The method of FIG. 5 further comprises presenting (504) at least a subset of the plurality of rows by: evaluating (506) the one or more user-relative functions; and selecting (508), based on the filter, the at least a subset of the plurality of rows. Evaluating (506) the one or more user-relative functions comprises calling the one or more user-relative functions included in the filter to return the corresponding attribute of a user accessing the referencing worksheet. Selecting (508), based on the filter, the at least a subset of the plurality of rows comprises selecting those rows satisfying the expression(s) of the filter using the returned attributes in place of the user-relative functions.

For example, assume a referencing worksheet inheriting a filter comprising the expression “‘Attorney Email’==user.email( )”. Further assume that the referencing worksheet is accessed by a user having an email address “Bob@law.firm.” The user-relative function “user.email( )” of the filter would evaluate (506) as “Bob@law.firm.” Thus, selecting (508), based on the filter, the at least a subset of the plurality of rows would comprise selecting, from the plurality of rows, those rows having an “Attorney Email” value of “Bob@law.firm.”

Further that the referencing worksheet is accessed by a user having an email address “Karen@law.firm.” The user-relative function “user.email( )” of the filter would evaluate (506) as “Karen @law.firm.” Selecting (508), based on the filter, the at least a subset of the plurality of rows would comprise selecting, from the plurality of rows, those rows having an “Attorney Email” value of “Karen@law.firm.” Thus, different users accessing reference worksheets with the same filter expression view different presentations of the same data set due to the user-relative functions.

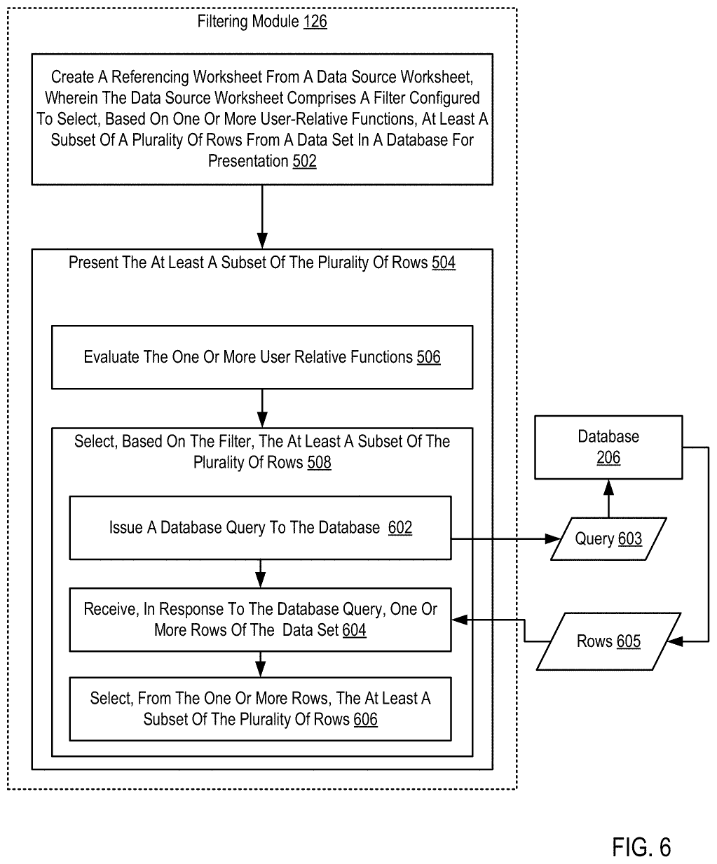

For further explanation, FIG. 6 sets forth a flow chart illustrating an exemplary method for row-level worksheet security according to embodiments of the present invention that includes creating (502) (e.g., by a filtering module (126)) a referencing worksheet from a data source worksheet, wherein the data source worksheet comprises a filter configured to select, based on one or more user-relative functions, at least a subset of a plurality of rows from a data set in a database for presentation; and presenting (504) at least a subset of the plurality of rows by: evaluating (506) the one or more user-relative functions; and selecting (508), based on the filter, the at least a subset of the plurality of rows.

FIG. 6 differs from FIG. 5 in that selecting (508), based on the filter, the at least a subset of the plurality of rows comprises issuing (602) a database query (603) to the database (206). The database query (603) may be based on worksheet metadata associated with the referencing worksheet. For example, the database query (603) may be based on a description of the data set, the presentation structure of the data set, formulas to be applied to the data set, and other data. The database query (603) may be based on the filter and the evaluated user-relative functions. The database query (603) may also be independent of the filter so that the response to the database query (603) may be subsequently filtered. The database query (422) may be an SQL statement. Issuing (602) the database query (603) to the database (206) may be carried out by the filtering module module (126) sending the database query (603) over a wide area network to the database (206) on the cloud-based data warehouse (192).

FIG. 6 differs from FIG. 5 in that selecting (508), based on the filter, the at least a subset of the plurality of rows also comprises receiving (604), in response to the database query (603), one or more rows (605) of the data set. For example, the filtering module (126) may receive, from the database (206), one or more rows (605) responsive to the database query (603) retrieved from the cloud-based data warehouse (192).

FIG. 6 differs from FIG. 5 in that selecting (508), based on the filter, the at least a subset of the plurality of rows also comprises selecting (606), from the one or more rows (605), the at least a subset of the plurality of rows. For example, where the issued (502) query (603) is based on the filter, the received (604) rows (605) satisfy the filter. Thus, selecting (606), from the one or more rows (605), the at least a subset of the plurality of rows may include selecting the received (604) rows (605) as the subset of the plurality of rows. Where the issued (502) query (603) is independent of the filter, selecting (606), from the one or more rows (605), the at least a subset of the plurality of rows may include selecting (606), as the at least a subset of the plurality of rows, those of the one or more rows (605) satisfying the filter.

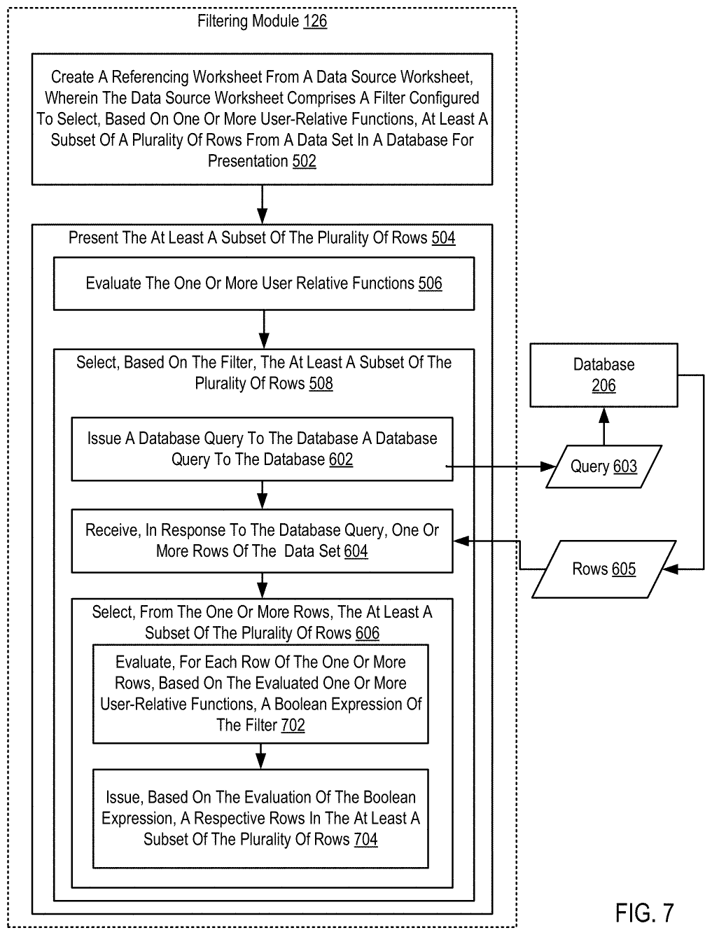

For further explanation, FIG. 7 sets forth a flow chart illustrating an exemplary method for row-level worksheet security according to embodiments of the present invention that includes creating (502) (e.g., by a filtering module (126)) a referencing worksheet from a data source worksheet, wherein the data source worksheet comprises a filter configured to select, based on one or more user-relative functions, at least a subset of a plurality of rows from a data set in a database for presentation; and presenting (504) at least a subset of the plurality of rows by: evaluating (506) the one or more user-relative functions; and selecting (508), based on the filter, the at least a subset of the plurality of rows by: issuing (602) a database query (603) to the database (206); receiving (604), in response to the database query (603), one or more rows (605) of the data set; and selecting (606), from the one or more rows (605), the at least a subset of the plurality of rows.

The method of FIG. 7 differs from FIG. 6 in that selecting (606), from the one or more rows (605), the at least a subset of the plurality of rows (606) comprises evaluating (702), for each row of the one or more rows (605), based on the evaluated one or more user-relative functions, a Boolean expression of the filter. For example, assume a referencing worksheet accessed by a user having an email address of “Karen@law.firm” and a filter including the Boolean expression “‘Attorney Email’==user.email( )”. The Boolean expression includes the user-relative function “user.email( )” which is configured to return the email address of the user accessing the referencing worksheet. This user-relative function has been evaluated (506) to return “Karen@law.firm.” Accordingly, the Boolean Expression “‘Attorney Email’'2==‘Karen@law.firm’” will be evaluated for the “Attorney Email” column of each returned row (605). The evaluation will return “TRUE” for every row having an “Attorney Email” column of “Karen@law.firm” and “FALSE” for all other rows.

The method of FIG. 7 differs from FIG. 6 in that selecting (606), from the one or more rows (605), the at least a subset of the plurality of rows (606) further comprises including (704), based on the evaluation of the Boolean expression, a respective row in the at least a subset of the plurality of rows. Including (704) a respective row in the at least a subset of the plurality of rows may comprise including the respective row when the evaluation of the Boolean expression for the respective row evaluates to “TRUE.” In other words, a respective row may be included in the at least a subset of the plurality of rows in response to satisfying an expression in the filter.

In view of the explanations set forth above, readers will recognize that the benefits of row-level worksheet security according to embodiments of the present invention include:
Improving the operation of a computing system by allowing varying presentations of data sets using the same filter formulas.
Improving the operation of a computing system by providing secured presentations of data sets by filtering according to user attributes.

Exemplary embodiments of the present invention are described largely in the context of a fully functional computer system for linking and composing worksheets. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of row-level worksheet security, the method comprising:
creating a referencing worksheet from a data source worksheet, wherein the data source worksheet comprises a function configured to select, based on one or more user-relative functions, at least a subset of a plurality of rows from a data set in a database for presentation;
presenting the at least a subset of the plurality of rows by:
evaluating the one or more user-relative functions; and
selecting, based on the filter, the at least a subset of the plurality of rows.

2. The method of claim 1, wherein the filter comprises at least a Boolean operation based on one or more columns of the data set.

3. The method of claim 1, wherein the one or more user-relative functions are configured to return, on execution, one or more attributes of a user account accessing the referencing worksheet.

4. The method of claim 1, wherein the filter is immutable in the referencing worksheet.

5. The method of claim 1, wherein selecting, based on the filter, the at least a subset of the plurality of rows comprises:
issuing a database query to the database;
receiving, in response to the database query, one or more rows of the data set; and
selecting, from the one or more rows, based on the filter, the at least a subset of the plurality of rows.

6. The method of claim 5, wherein selecting, from the one or more rows, based on the filter, the at least a subset of the plurality of rows comprises:
evaluating, for each row of the one or more rows, based on the evaluated one or more user-relative functions, a Boolean expression of the filter; and
including, based on the evaluation of the Boolean expression, a respective row in the at least a subset of the plurality of rows.

7. The method of claim 1, presenting the at least a subset of the plurality of rows comprises presenting the at least a subset of the plurality of rows in a graphical user interface (GUI).

8. An apparatus for row-level worksheet security, the apparatus comprising a computer processor, a computer memory operatively coupled to the computer processor, the computer memory having disposed within it computer program instructions that, when executed by the computer processor, cause the apparatus to carry out the steps of:
creating a referencing worksheet from a data source worksheet, wherein the data source worksheet comprises a configured to select, based on one or more user-relative functions, at least a subset of a plurality of rows from a data set in a database for presentation;
presenting the at least a subset of the plurality of rows by:
evaluating the one or more user-relative functions; and
selecting, based on the filter, the at least a subset of the plurality of rows.

9. The apparatus of claim 8, wherein the filter comprises at least a Boolean operation based on one or more columns of the data set.

10. The apparatus of claim 8, wherein the one or more user-relative functions are configured to return, on execution, one or more attributes of a user account accessing the referencing worksheet.

11. The apparatus of claim 8, wherein the filter is immutable in the referencing worksheet.

12. The apparatus of claim 8, wherein selecting, based on the filter, the at least a subset of the plurality of rows comprises:
issuing a database query to the database;
receiving, in response to the database query, one or more rows of the data set; and
selecting, from the one or more rows, based on the filter, the at least a subset of the plurality of rows.

13. The apparatus of claim 12, wherein selecting, from the one or more rows, based on the filter, the at least a subset of the plurality of rows comprises:
evaluating, for each row of the one or more rows, based on the evaluated one or more user-relative functions, a Boolean expression of the filter; and
including, based on the evaluation of the Boolean expression, a respective row in the at least a subset of the plurality of rows.

14. The apparatus of claim 8, presenting the at least a subset of the plurality of rows comprises presenting the at least a subset of the plurality of rows in a graphical user interface (GUI).

15. A computer program product for linking and composing worksheets, the computer program product disposed upon a computer readable medium, the computer program product comprising computer program instructions that, when executed, cause a computer to carry out the steps of:
creating a referencing worksheet from a data source worksheet, wherein the data source worksheet comprises a configured to select, based on one or more user-relative functions, at least a subset of a plurality of rows from a data set in a database for presentation;
presenting the at least a subset of the plurality of rows by:
evaluating the one or more user-relative functions; and
selecting, based on the filter, the at least a subset of the plurality of rows.

16. The computer program product of claim 15, wherein the filter comprises at least a Boolean operation based on one or more columns of the data set.

17. The computer program product of claim 15, wherein the one or more user-relative functions are configured to return, on execution, one or more attributes of a user account accessing the referencing worksheet.

18. The computer program product of claim 15, wherein the filter is immutable in the referencing worksheet.

19. The computer program product of claim 15, wherein selecting, based on the filter, the at least a subset of the plurality of rows comprises:
issuing a database query to the database;
receiving, in response to the database query, one or more rows of the data set; and
selecting, from the one or more rows, based on the filter, the at least a subset of the plurality of rows.

20. The computer program product of claim 19, wherein selecting, from the one or more rows, based on the filter, the at least a subset of the plurality of rows comprises:
evaluating, for each row of the one or more rows, based on the evaluated one or more user-relative functions, a Boolean expression of the filter; and
including, based on the evaluation of the Boolean expression, a respective row in the at least a subset of the plurality of rows.
